(19) United States
(12) Patent Application Publication
(10) Pub. No.: US 2006/0053977 A1
(43) Pub. Date: Mar. 16, 2006

(54) Apparatus and method for assembling and disassembling downhole components in a horizontal mode

(76) Inventor: Samuel P. Hawkins III, Lafayette, LA (US)

Correspondence Address: THE MATTHEWS FIRM, 2000 BERING DRIVE, SUITE 700, HOUSTON, TX, 77057, US

(21) Appl. No.: 10/942,356

(22) Filed: Sep. 16, 2004

(51) Int. Cl. B25B 13/50; B25B 17/00

(52) U.S. Cl. 81/57.34

(57) ABSTRACT

A downhole component handling apparatus and method for making up and breaking out a series of threaded connections for downhole components functionally oriented in a horizontal mode, away from a wellbore. The apparatus includes a plurality of tri-axial alignment structures for selectively leveling and positioning downhole components in a horizontal orientation with respect to a datum axis of a power tong system. The power tong system is configured for more effectively making up threaded connections of a series of downhole components for ready installation downhole into a wellbore or breaking out a series of threadedly connected downhole components for disassembly.

### RELATED APPLICATION

The present application includes structure that relates to patent application Ser. No. 10/139,525, filed on May 6, 2002 and now issued as U.S. Pat. No. 6,752,044 B2.

### FIELD OF INVENTION

This invention relates generally to a downhole component handling apparatus and method for aligning, making up, and breaking out a series of threaded connections for downhole assemblies or downhole components oriented in a horizontal mode. The apparatus and method according to the invention may be used off-site away from a rig, or on-site at or near the rig, and provides various safety, cost, and time savings benefits. Using the invention for making up or breaking out downhole assemblies off-site or away from the wellbore of the drilling rig saves substantial rig time resulting in potential cost savings of thousands of dollars.

### BACKGROUND OF THE INVENTION

It is well known in the oil and gas field to assemble and disassemble downhole components on-site at a drilling rig and vertically over a wellbore. There are many prior art devices configured, in a conventional manner, for vertically making up downhole components such as drill pipe while running a pipe string into a wellbore and then breaking out individual joints while coming out of the wellbore.

Many of these prior art devices are specifically configured for only making up and breaking out the downhole components, such as drill string, while oriented vertically. That is, most prior art devices only contemplate handling downhole components on-site at a rig and directly over the wellbore in such a way that the downhole components must be suspended from the mast rigging and rig slips.

Exemplary of such devices are the following:

U.S. Pat. No. 4,843,945 to Dinsdale, entitled “Apparatus for Making and Breaking Threaded Well Pipe Connections; and

U.S. Pat. No. 5,868,045 to Hauk, entitled “Apparatus for Making and Breaking Joints in Drill Pipe Strings”

These devices and methods for handling individual downhole components may be inefficient due the fact that the vertically suspended downhole components are generally extremely heavy and are awkward to readily maneuver and align for make up and break out. Many of these devices require substantial time to assemble or disassemble a drill string because they are adapted for handling only one 30-foot component or drill pipe at a time. That is, the drill string must be suspended vertically and made up or broken out one 30-foot pipe section at a time rather than two or three pipe sections at a time.

With many of these conventional devices and methods, downhole components such as 30-foot drill string pipe, stabilizers, centralizers, etc., must be suspended above rig workers, via the mast and rigging, while the workers align and mate each pipe tool joint for make up. The pipes then must be threadably connected by wrench structures specifically oriented to only handle the single pipe or component suspended vertically. With individual components such as a drill pipe suspended vertically, pipe-by-pipe handling for make up and break out with power wrenches and the like can be very time consuming for the crew. Moreover, pipe threads of the joint pin and box can be severely damaged if the pipe is lowered too quickly while attempting to align and connect the pipe.

There has been a device in the oil and gas field that is somewhat adapted for horizontal make up and break out of some kinds of possibly lighter-weight downhole components. The device is described in an advertising publication by Scorpion-Tong as a Model 2000 LRT-Dual Position, a Break Out Make Up Dual Position Hydraulic Chain Tong. However, this device advertises that no back up or lifting equipment is needed; this may make it difficult to support and balance long, heavy downhole components during make up and break out operations. This chain-tong device also is not configured with a power spinner which is needed to more rapidly make up and break out threaded joints. Moreover, the device rests on a small base a portion of which includes two small wheels. Accordingly, it is difficult to align two 30-foot drill pipe sections with such a device and then make up or breakout a threaded connection. With such a small base, it is cumbersome and risky to simultaneously balance, accurately align, and quickly join two 30-foot pipe sections to create a made up 60-foot downhole pipe section. Of course, break out of such a long pipe section could be even more cumbersome during disassembly and after actual separation of the two pipe sections.

Accordingly, there has been a long felt need for an apparatus and method of handling downhole components for make-up and break-out in a safer, more efficient, and cost-effective manner and in a horizontal mode.

### BRIEF DESCRIPTION OF DRAWINGS

For a further understanding of the nature of the present invention, reference should be had to the following brief description of the drawings, wherein:

FIG. 1 is a perspective, isometric view of a downhole component handling apparatus according to the present invention for aligning, making up, and breaking out a series of threaded connections for downhole components oriented in a horizontal mode off a wellbore.

FIG. 2 is a perspective, isometric view of the control panel of the apparatus according to FIG. 1;

FIG. 3 is a fragmentary isometric perspective view of a power tong system used in the apparatus according to the invention; and

FIG. 4 is a side view of a portion of a power tong used in the apparatus according to the invention.

### DETAILED DESCRIPTION OF THE PREFERRED EMBODIMENT

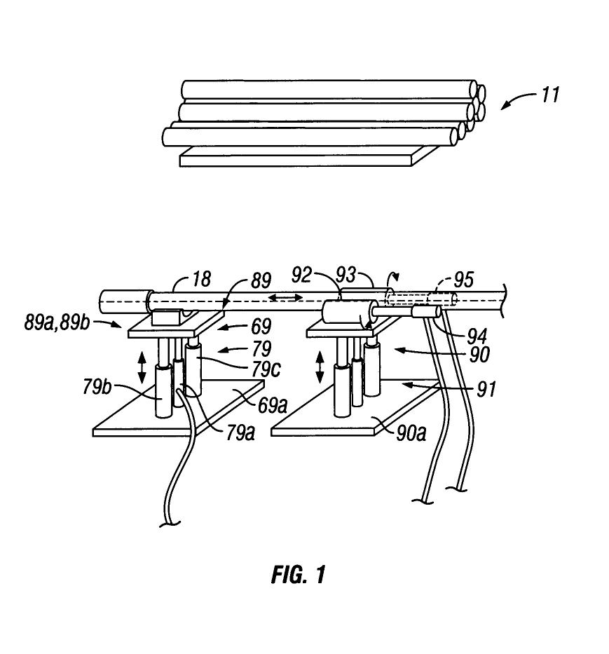

Referring now to the drawings in more detail, FIG. 1 illustrates an apparatus 10 for horizontally making up and breaking out threaded connections of downhole components away from a wellbore resulting in substantial drilling rig time and cost savings depending on the well. The downhole components (e.g., components 16, 18) may be made up, in a horizontal mode, for subsequent insertion in a drilling string or one assembly. Alternately, with apparatus 10, downhole components may also be broken out, in a horizontal mode, after removal from the wellbore.

The apparatus 10 is especially adapted for alignment, make up, and break out of downhole components oriented horizontally along their longitudinal axis away from a wellbore. Thus, the apparatus 10 may be used in a variety of locations, as is convenient, such as a manufacturing shop, shipping dockyard (for shipment to an offshore rig), an offshore floating barge or the like, or a suitable work area near a drilling rig. The apparatus 10 is preferably set up on the shop floor 12 or rig tarmac, near a pipe storage rack 11 or the like, where downhole components such as drill string pipe, etc., are stored. A shop hoist 14 or the like may be used to relocate a first downhole component 16 and a second downhole component 18 and place them horizontally as shown in FIG. 1.

It should be appreciated that the downhole components 16, 18 are generally drill pipes but also may include a drill bit, stabilizer, centralizer, tubulars, or other bottom hole/downhole components. Of course, the components handled could include other types of threadedly connected structures as well not necessarily used downhole. The invention 10 includes a plurality of alignment structures such as, preferably, alignment platforms 66-69 which may be used for selectively manipulating and aligning at least two downhole components away from the wellbore in a generally horizontal orientation or mode.

The invention 10 also includes a power tong system 20 having a slot 24 or opening with a central axis 40 with the slot being adapted to receive at least two downhole components (e.g., components 16, 18). The power tong system 20 is configured for making up or breaking out threaded connections of a plurality of downhole components which can be selectively manipulated horizontally by the plurality of downhole component handling and alignment structures (e.g., 66-69) and for tri-axially aligning at least two of the downhole components 16, 18 with the power tong system central axis 40.

The apparatus 10 preferably includes a power tong system 20 which is different from power tong systems conventionally used in vertical make up and break out operations. In the preferred embodiment of the invention, the power tong system 20 is mounted on a base frame 22 such that it is rotated 90 degrees from the normal vertical orientation and is instead configured for use in a horizontal manner. The horizontally oriented power tong system 20 has a slot 24 or opening for longitudinally receiving downhole components 16, 18, with at least two power tongs (e.g., first and second power tongs) 26,28 configured for supporting, gripping and applying torque to the first and second downhole components 16, 18.

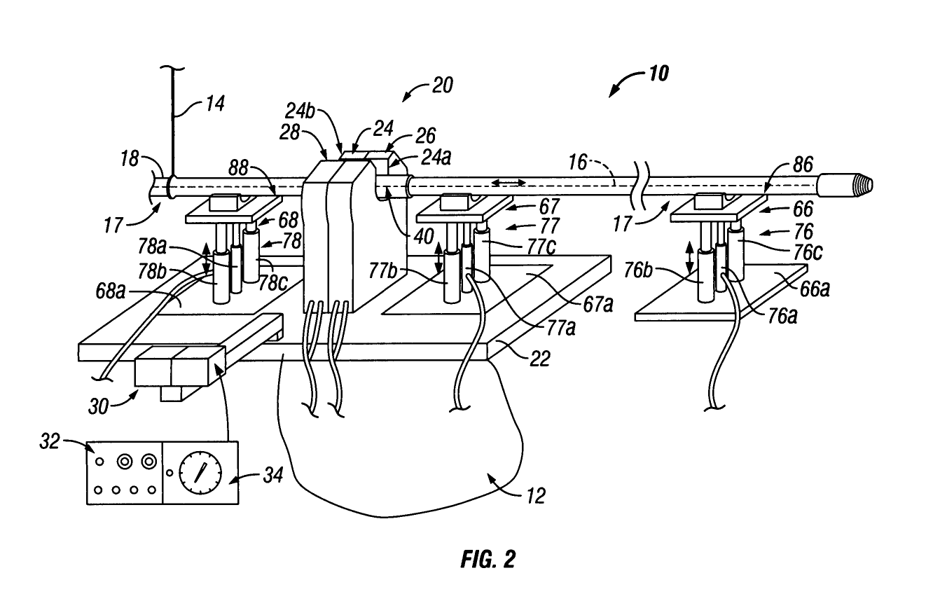

As illustrated in FIG. 2, the power tong system 20 is preferably activated using a control panel 30 having controls 32 to actuate the first power tong 26 for gripping and fixedly holding the first downhole component and to simultaneously actuate the second power tong 28 for gripping and applying torque to the second downhole component 18 during make up or break out. The control panel 30 also includes a gauge 34 to monitor the torque being applied by the second power tong 28. The control panel 30 is mounted to the base frame 22 and preferably extends to the front side of the apparatus 10 as shown in FIG. 2.

In the preferred embodiment of the invention, the location of the control panel 30 as shown in FIG. 1 establishes an operational viewpoint for identifying the location of the various elements of the apparatus 10 according to the invention. As will be explained hereinafter, elements located to the left side of the control panel 30 are referred to as being located on the torque-side of the horizontal power tong system 20 (since the left-side, second tong 28 applies torque). Elements located to the right side of the control panel are referred to as being located on the fixed-side of the power tong system 20 (since the first tong 26, on the right side fixedly holds the first downhole 16 in place during make-up or break-out). Of course, a person of ordinary skill in the art would understand that the positions of the first and second power tongs 26, 28 could be reversed such that the torque-side and fixed-side would be reversed as well.

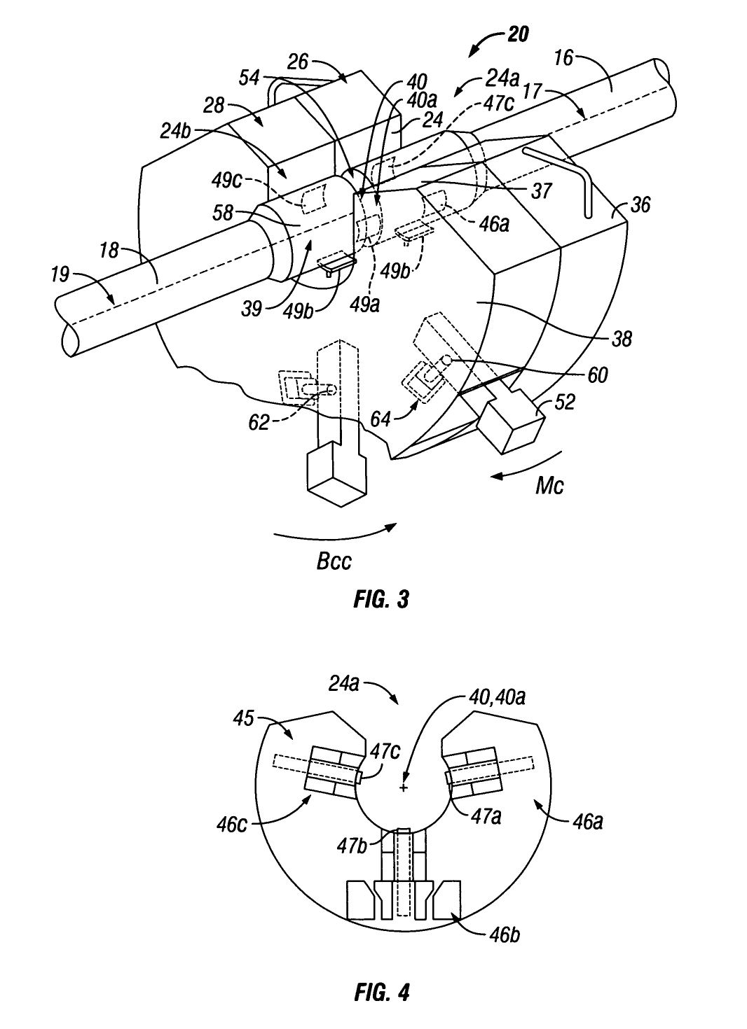

Referring now to FIGS. 3 and 4, the power tong system 20 is illustrated in more detail. The first power tong 26 has a housing 36 with a first slot 24a opening preferably upwardly with respect to the base frame 22 shown in FIG. 1. As shown in FIGS. 3 and 4, the first tong slot 24a has a central axis 37 which establishes in part a “datum axis” 40 of the power tong system 20. The slot 24 has a center point 40a which lies on the datum axis 40 between the first and second tongs. The center point 40a is used as a reference point for positioning elements of the apparatus with respect to the power tong system 20. The first power tong 26 also includes a plurality of gripping assemblies 46a, 46b, 46c attached to a mounting structure 36a within the first housing 36. The plurality of gripping assemblies 46a, 46b, 46c include a plurality of bite dies 47a, 47b, 47c, respectively, adapted to move inwardly and outwardly for gripping and fixedly holding and releasing the first downhole component 16 during make up and break out.

The bite dies 47a, 47b, 47c are preferably positioned circumferentially and equidistantly around the longitudinally extending datum axis 40 of the power tong system 20 as shown in FIGS. 3 and 4.

The second power tong 28 has a housing 38 with a second slot 24b also opening preferably upwardly with respect to the base frame 22. The second slot 24b, like the first slot 24a, also has a central axis 39 which establishes in part the “datum axis” 40 of the power tong system 20. Referring specifically to FIG. 3, the second power tong 28 also includes a plurality of gripping assemblies (not shown but similar to 46a, 46b, 46c) attached to a mounting structure within the second housing 38. The plurality of gripping assemblies include a plurality of bite dies 49a, 49b, 49c adapted to move inwardly and outwardly for gripping and fixedly holding and releasing the second downhole component 18 during make up and break out.

The bite dies 49a, 49b, 49c are also preferably positioned circumferentially and equidistantly around the longitudinally extending datum axis 40 of the power tong system 20 as shown in FIG. 3. However, the second power tong 28 also includes a pivot arm 52 which is adapted to rotate the combination of gripping assemblies and bite dies 47a, 47b, 47c, along with a second downhole 18 gripped therein, clockwise for make up (as viewed longitudinally from the torque-side (i.e., left-side) of the power tong system 20). That is, the second tong applies torque to the second downhole component while the first downhole component is fixedly (i.e., non-rotably) held in place by the first tong 26. In this way, the second tong performs final tightening or make up of the threaded joint 54 between the first and second downhole components. For example, as illustrated in FIG. 3, when connecting two typical drill pipes, the box 56 of the first downhole component 16 is fixedly held by the first tong 26 while the second tong applies the make up torque to the pin 58 of the second downhole component to perform final make up of the joint 54.

As shown in FIG. 3, the clockwise rotation of the pivot arm 52 for make up is designated by the letters Mc. The second power tong housing 38 has two apertures 60, 62 adapted to receive a pivot arm pin 64. When the pivot arm pin 64 is secured in aperture 60, the second tong when actuated, rotates clockwise (as designated by Mc) for make up operations. When the pivot arm pin 64 is secured in aperture 62, the pivot arm and second tong 28, when actuated, rotates counterclockwise for break out operations as designated by the letters Bcc.

The power tong system 20 also includes a grip control circuit (not shown) for controlling the bite dies 47a-47c, 49a-49c of the first and second power tongs 26, 28. The grip control circuit is operated to cause the first power tong 26 to apply a first grip pressure and the second power tong 28 to apply a second grip pressure during make up and break out. The system also includes a pivot arm control circuit (not shown) for applying torque which is also indicated by the gauge 34 on the control panel 30.

Referring to FIGS. 1 and 3, the apparatus 10 also includes a plurality of alignment platforms 66-69 preferably configured for simultaneously handling the first and second downhole components 16, 18. The alignment platforms are raised and/or lowered by the operator via the control panel. The operator can manipulate the controls to selectively raise and lower the alignment platforms 66-69 in order to tri-axially align (as explained hereinafter) the longitudinal axes 17, 19 of the downhole components 16, 18, respectively, with the datum axis 40 of the power tong system 20.

For example, for make-up of the downhole components 16, 18, tri-axial alignment, of the axes 17, 19 of downhole components 16, 18 and the datum axis 40, is accomplished by selectively raising and lowering the alignment platforms 66-69 and, at the same time, using conventional means such as levels or other leveling and alignment devices to line up box 56 and pin 58 of the downhole components 16, 18, respectively. As a result, the threads of box 56 and pin 58 shown in FIG. 3 can be made up.

As illustrated in FIG. 1, the fixed-side alignment platforms 66,67 are first actuated to position the first downhole component 16 within the first power tong 26. The first power tong 26 is then actuated to fixedly grip the box 56 of downhole component 16.

It is important to recognize that when the first downhole component 16 is fixedly gripped by the bite dies 47a-47c (which are circumferentially arranged around and equidistant from the datum axis 40 of the power tong system 24 as shown in FIGS. 3 and 4), the central axis 17 of the box 56 will, at the same time, co-axially be aligned with the datum axis 40.

Next, the torque-side alignment platforms 68, 69, shown in FIG. 1, are selectively raised or lowered using the control panel 32 to position downhole component 18 within the second power tong 28. The second power tong is then actuated to grip the pin 58 of downhole component 18.

As with downhole component 16, when the second downhole component 18 is gripped by the bite dies 49a-49c (which are circumferentially arranged around and equidistant from the datum axis 40 of the power tong system 24 as shown in FIGS. 3 and 4), the central axis 19 of the pin 58 will be, at the same time, co-axially aligned with the datum axis 40. In this way, the three axes (i.e., including the datum axis 40 and the first and second downhole component axes 17, 19) are aligned for make up.

For break out of connected downhole components, the connected components are first placed on alignment platforms 66-69 in a similar manner as shown in FIGS. 1 and 3. The alignment platforms 66-69 are then selectively raised and lowered and the downhole components (e.g.,16, 18) are moved axially such that the box 56 and pin 58 are positioned as required within the openings 24a, 24b of the first and second power tongs 26, 28, respectively. The box 56 and pin 58 (such as those shown in FIG. 3) are positioned and aligned within the power tong system 24 such that box 56 and pin 58 may be gripped by the bite dies 47a-47c and 49a-49c, respectively. In this way, the three axes, including the datum axis 40 and the first and second downhole component axes 17, 19, will be aligned for break out.

It should be appreciated that as configured, in a horizontal mode, the invention is especially adapted to facilitate proper alignment, make up, and break out of the threaded connections of bottom hole assemblies or downhole components. That is, by supporting the weight of the components horizontally, via the alignment platforms, rather than vertically in a suspended mode via the rig mast, the force of gravity does not create the same axial shear or compression forces on the base of the threads of the box/pin joint during make up. The operator of the invention can more readily handle the weight of the downhole components by manipulating the alignment platforms as required to properly align and mate the threads of the box/pin joint. In this way, the invention is adapted to help avoid damage to the threads during make up. This feature in turn may help to improve “joint integrity” to help minimize to possibility of joint problems occurring later on such as when lowered downhole. It should be appreciated that “joint integrity” is especially critical during downhole drilling operations, after the drill string, comprised of hundreds of made up joints, is located 5,000-10,000 feet downhole.

Referring now to FIGS. 1-3, during initial set up of the apparatus 10, the alignment platforms 66-69 are positioned at a predetermined distance, with respect to each other and the centerpoint 40a of slot 24 of the power tong system. The respective distances and positions of the alignment platforms 66-69 are as designated by the letters Df1, Df2 (for the fixed-side platforms 66, 67), and Dt1, Dt2 (for the torque-side platforms 68,69). The positions of the platforms 66-69 will depend on the lengths of the downhole components being handled. The lengths of the downhole components are designated by the letters Lw1 and Lw2. For example, a typical drill pipe is about 30 feet long. Thus, the alignment platforms would be positioned so as to be able to adequately support the pipes.

In the preferred embodiment, the two alignment platforms 66, 67 to right of the power tongs, (referred to as the fixed-side, first and second alignment platforms) are used to align and position the first downhole component 16 with respect to the datum axis 40 and the first tong 26. The two alignment platforms 68, 69 to the left of the power tongs (referred to as the torque-side, first and second alignment platforms) are used to align and position the second downhole component 18 with respect to the datum axis 40 and the second power tong 28.

With these four alignment platforms 66-69, the apparatus 10 is configured such that it may be used to tri-axially align the first and second downhole component axes 17, 19 with the datum axis 40 for proper make up and break out operations.

In addition, the apparatus 10 includes an alignment platform circuit (not shown) for selectively activating the alignment platforms to preferably level and transport the downhole components 16, 18 for make up and break out.

Referring again to FIG. 1, each of the alignment platforms 66-69 is constructed and functions in a similar manner with the exception of each of their bases. The bases 67a, 68a of alignment platforms 67, 68, respectively, are preferably fixedly secured directly to the base frame 22 while the bases 66a, 69a of alignment platforms 66, 69 are selectively movable. As the alignment platforms 66-69 are similar, only the construction of the torque-side second alignment platform 69 will be explained herein.

The base 69a of the alignment platform 69 is adapted to support a leveler assembly 79 and a roller assembly 89. The roller assembly 89 preferably comprises a pair of adjustable roller members 89a, 89b for supporting a downhole component; the roller members are adapted for helping to selectively move downhole components into or withdraw them out of the slot 24 of the power tong system 20 during make up and break out operations. Each of the roller members may be driven by electric motors to facilitate axial transport of the downhole components.

The leveler assembly 79 of the alignment platform is mounted to the base 69a and preferably includes a leveler member 79a which functions in cooperation with a pair of guide members 79b, 79c for selectively aligning downhole components carried on the platform vertically with respect to the datum axis 40 of the power tong system 20. Each of the leveler members 76a, 77a, 78a, 79a (of the four alignment platforms 66-69) is preferably constructed from a hydraulic piston and cylinder apparatus 10 and is actuated via a hydraulic line. The leveler members 76a, 77a, 78a, 79a are raised and lowered using the control panel 30.

In addition, the apparatus 10 includes a power spinner 90 preferably positioned at a predetermined distance, as designated by the letters Dp, from the centerpoint 40a of slot 24 as suitable depending on the length of the downhole component being handled. For example, if the second downhole component is a 30-foot drill pipe, the power spinner 90 is preferably positioned about 10-15 feet to the left of the slot centerpoint 40a. The power spinner 90 is configured for use in spinning the second downhole component 18 prior to final make up and after initial break out of the downhole components. The power spinner preferably comprises a movable base 90a and leveler assembly 91 which is constructed and functions in a similar manner to the leveler assemblies 76-79 of alignment platforms 66-69. Preferably mounted atop the leveler assembly is a pair of longitudinal rollers 92, 93 supported by a plurality of bearings with each of the rollers being driven by a pair of electric motors 94, 95, respectively. The outer surface of each of the longitudinal rollers 92, 93 is preferably formed from a material, such as, but not limited too, rubber, adapted to make engaging contact with the second downhole component 18 to spin it clockwise (for make up) or counterclockwise (for break out) as viewed from the torque-side of the power tong system 20. This configuration helps prevent the second downhole component 18 from slipping while being rotated. In this way, the second downhole component 18 is rotably cradled by the power spinner 90.

In addition, as mentioned above the (at least two) power tongs 26, 28 each have a central axis 37, 39 respectively oriented co-axially and horizontally with respect to each other (i.e., to form datum axis 40). The power spinner rollers 92, 93 each have a central axis oriented generally parallel with respect to the central axis or datum axis 40 of the power tongs 26, 28.

As with the alignment platforms 66-69, the power spinner leveler member 91 a functions in cooperation with a pair of guide members 91b, 91c for selectively aligning the second downhole component 18 vertically with respect to the datum axis 40. The leveler member 91a is also preferably constructed from a hydraulic piston and cylinder combination.

In addition, the apparatus 10 includes a power spinner control circuit (not shown) to produce a spin control signal which is used to selectively rotate both longitudinal rollers 92, 93 “counterclockwise” to impart clockwise rotation to the second downhole component 18 for make up and conversely, “clockwise” to impart counterclockwise rotation for break out. The rollers of the power spinner 92, 93 are preferably rotated at about 200 to 300 revolutions per minute during make up and break out operations. It should be appreciated that the power spinner is configured such that the torque imparted by the power spinner motors combined with the engaging rotational contact surface of the rollers 92, 93 with the second downhole component 18 is sufficient for only “spinning up” the joint. The “spin up” torque is not sufficient, and not intended, for final making up of the joint. Instead, the second power tong 28 is especially configured for final make up of the joint to help ensure “joint integrity.” The final make up torque applied by the second power tong 28 is monitored at the torque gauge 34 on the control panel 32 to ensure that the proper torque is applied to the second downhole component 18 while the first downhole component 16 is fixedly held within the power tong 26 during make up or break out.

In the preferred embodiment of the invention, the first and second power tongs 26, 28 are actuated via a plurality of hydraulic lines. The alignment platforms leveler members 76a, 77a, 78, 79a and the electric power spinner leveler member 91a are also actuated via hydraulic lines. The various elements of the apparatus 10 are controlled by the control panel 30. (The hydraulic power source and electrical power source needed to operate the invention are not shown.)

In the initial stage of the make up operation of the apparatus 10 illustrated in FIGS. 1-4, the torque-side and fixed-side alignment platforms 66-69 are located at a predetermined distance from the slot 24 of the power tong system 20 as suitable depending on the length of the downhole component being handled. For example, as illustrated in FIGS. 1 and 3, the apparatus 10 is used to first make up two 30-foot drill pipes 16,18 both having a threaded pin and box (e.g., 58, 56).

Next, the first drill pipe 16 is hoisted from rack 11 and placed horizontally on top of the fixed-side alignment platforms 66, 67 as illustrated in FIG. 1. The second drill pipe 18 is then hoisted from rack 100 and placed horizontally on top of the torque-side alignment platforms 68, 69.

The operator then manipulates the LIFT UP/DOWN controls 32 as necessary on the control panel 30 to roughly align the first drill pipe 16 (via alignment platforms 66, 67) and the second drill pipe 18 (via alignment platforms 68, 69 and power spinner 90) with the datum axis 40 of the power tong slot 24. The circumferentially arranged gripping assembly bite dies 47a-47c and 49a-49c are equidistant from and establish the longitudinally extending datum axis 40. Both pipes are then advanced into the slot 24 and checked again for proper alignment and pin/box thread engagement preferably using conventional levels or other aligning structures.

Once aligned, the gripping assemblies 46a, 46b, 46c of the first tong 26 are then actuated using the GRIP controls 32 as necessary to grip and fixedly hold the first pipe 16. Then, the power spinner 90 is actuated to spin the second pipe 18 with respect to the first pipe 16 until the joint 54 is almost made up. Next, the grip assemblies of the second tong 28 are actuated using the GRIP controls 32 as necessary to grip the second pipe 18. The TORQUE/MAKE UP control is then used to apply the necessary torque (as indicated on th gauge 34) for final making up.

Of course, a person of ordinary skill in the art would recognize that the apparatus 10 could be configured to make up a third drill pipe. That is, two additional alignment platforms could be located on the fixed-side of the power tong system 20 and the two made up pipes could be repositioned to rest completely on the fixed-side. Then, a third pipe could be hoisted into position on the torque-side and the above make up process could be repeated to make up the third pipe with the already joined first and second pipes 16, 18.

It should be recognized that additional alignment platforms could be included with the apparatus 10 and positioned as suitable to facilitate handling the third pipe or a section of drill pipe for example having more than three connected pipes or bottom hole assemblies. Also, more than one power spinner could also be used to facilitate the process.

Conversely, in the initial stage of the break out operation of the apparatus 10 illustrated in FIGS. 1 and 3, the two joined drill pipes 16, 18 (or more as suitable) are hoisted onto the apparatus 10 such that the box 56 of the made up joint 54 is positioned in the first tong slot 24a and the pin 58 is positioned in the second tong slot 24b.

Referring now specifically to FIG. 3, the pivot arm 52 must be moved downwardly such that the pivot arm pin 64 can be relocated into aperture 62 in order for the pivot arm 52 and second tong 28 to be able to rotate counterclockwise and apply break out torque.

Next, the LIFT UP/DOWN controls 32 are manipulated as necessary on the control panel 30 to align the made up joint 54 with the datum axis 40 of the power tong slot 24. Conventional levels or aligning devices may also be used as required to aid in mating the joint threads.

The gripping assemblies 46a, 46b, 46c of the first tong 26 are then actuated using the GRIP controls 32 as necessary to grip and fixedly hold the box 56 of the first pipe 16. Next, the gripping assemblies of the second tong 28 are actuated using the GRIP controls 32 as necessary to grip the pin 58 of the second pipe 18. The TORQUE/BREAKOUT control is then used to apply the necessary torque to break out the connection.

Then, the power spinner 90 is actuated to spin the second pipe 18 with respect to the first pipe 16 until the joint 54 is completely broken out.

Again, it should be recognized that additional alignment platforms could be included with the apparatus 10 and positioned as suitable to facilitate handling a third pipe or a section of drill pipe for example having more than three connected pipes or bottom hole assemblies for break out operations. Also, more than one power spinner could also be used to facilitate the process.

In view of any one of the manners discussed herein or in any combination thereof, make up and break out in a horizontal mode is achieved. It may be seen from the preceding description that a new apparatus and method for make up and break out of downhole components has been provided. Although very specific examples have been described and disclosed, the invention of the instant application is considered to comprise and is intended to comprise any equivalent structure.

The foregoing disclosure and description of the invention is therefore illustrative and explanatory of one or more presently preferred embodiments of the invention and variations thereof, and it will be appreciated by those skilled in the art that various changes in the design, organization, order of operation, means of operation, equipment structures and location, methodology, and use of mechanical equivalents, as well as in the details of the illustrated construction or combinations of features of the various elements, may be made without departing from the spirit of the invention. As well, the drawings are intended to describe the concepts of the invention so that the presently preferred embodiments of the invention will be plainly disclosed to one of skill in the art but are not intended to be manufacturing level drawings or renditions of final products and may include simplified conceptual views as desired for easier and quicker understanding or explanation of the invention. As well, the relative size and arrangement of the elements of the invention may be greatly different from that shown and still operate well within the spirit of the invention as described hereinbefore and in the appended claims. It will be seen that various changes and alternatives may be used that are contained within the spirit of the invention. Moreover, it will be understood that various directions such as “top,” “bottom,” “left,” “right,” “inwardly,” “outwardly,” and so forth are made only with respect to easier explanation in conjunction with the drawings and that the elements may be oriented differently, for instance, during transportation and manufacturing as well as operation. Because many varying and different embodiments may be made within the scope of the inventive concept(s) herein taught, and because many modifications may be made in the embodiment herein detailed in accordance with the descriptive requirements of the law, it is to be understood that the details herein are to be interpreted as illustrative and not in a limiting sense.

What is claimed is:

1. An apparatus for making up and breaking out threaded connections of downhole components, away from a drilling rig wellbore, with downhole components being made up for subsequent insertion in a drilling string or assembly, or alternately, downhole components being broken out after removal from the wellbore, comprising:
a plurality of alignment structures for selectively manipulating and aligning in a generally horizontal mode at least two downhole components away from the wellbore; and
a power tong system having an opening with a central axis, said opening being adapted to receive the at least two downhole components, wherein said power tong system is configured for making up and breaking out a threaded connection of the at least two downhole components selectively manipulated and aligned by said plurality of alignment structures after horizontal alignment of the central axes of the at least two downhole components with said power tong system central axis.

2. An apparatus for making up and breaking out threaded connections of downhole components, away from a drilling rig wellbore, with downhole components being made up for subsequent insertion in a drilling string or assembly, or alternately, downhole components being broken out after removal from the wellbore, comprising:
a plurality of alignment platforms adapted for transporting or aligning in a generally horizontal mode a first downhole component and a second downhole component, each of said first and second downhole components having a central axis; a first power tong having an opening with a central axis, said first power tong being configured such that said opening may receive the first downhole component being moved into said opening, wherein at least two of said plurality of alignment platforms are configured for being actuated to foster tri-axial alignment in a horizontal orientation of the first downhole component with respect to said central axis of said first power tong opening and the central axis of the second downhole component, and wherein said first power tong is adapted for gripping and holding in a fixed position the first downhole component, said first power tong holding the first downhole component with a first grip pressure;
a second power tong having an opening with a central axis which is co-axial with said opening of said first power tong, said second power tong being configured such that said second power tong opening may receive the second downhole component being moved into said second power tong opening, and wherein at least two of said plurality of alignment platforms are configured for facilitating horizontal alignment of the central axis of the second downhole component tri-axially with respect to said central axis of said second power tong and the central axis of the first downhole component, and wherein said second power tong is adapted for gripping and holding the second downhole component with a second grip pressure, and wherein said second power tong is adapted for applying sufficient torque for a final making up or breaking out of the threaded connection, said second power tong gripping respective of the second downhole component with a second grip pressure for said applying of sufficient torque;
an alignment platform circuit for activating said alignment platforms for leveling and positioning the downhole components; and
a grip control circuit for controlling said first power tong and said second power tong, said grip control circuit being operable for selectively applying a first grip pressure to the first downhole component by said first power tong and for selectively applying a second grip pressure to the second downhole component by said second power tong so as to make up and break out the threaded connection of the first and second downhole components.

3. The apparatus of claim 2, further comprising:
a power spinner configured for being aligned with the central axis of the second downhole component, wherein said power spinner has rolling members adapted to rotably cradle the second downhole component so as to selectively rotate the second downhole component with respect to the first downhole component, said power spinner being adapted for use during making up or breaking out of the threaded connection.

4. The apparatus of claim 3, further comprising:
a power spinner control circuit to produce a spin control signal, wherein said spin control signal is used to selectively rotate the downhole components during making up and breaking out.

5. The apparatus of claim 3, further comprising:
at least two power tongs each having a central axis oriented horizontally with respect to each other, wherein said power spinner has at least two spin-up rollers each having a central axis oriented horizontally with respect to said at least two power tongs.

6. The apparatus of claim 2, further comprising:
a base frame configured for mounting said first and second power tongs.

7. The apparatus of claim 2, further comprising:
a base frame configured for mounting at least one of said plurality of alignment platforms.

8. The apparatus of claim 2, further comprising:
a base frame for mounting said first and second power tongs and for fixedly securing at least one alignment platform horizontally and laterally with respect to said power tongs so as to foster tri-axial alignment of at least one downhole component with respect to said power tongs.

9. The apparatus of claim 2, wherein each of said first and second power tongs has a plurality of dies circumferentially and substantially equidistantly arranged with respect to said central axis of said power tong openings so as to establish a reference datum axis of said power tong system to facilitate alignment of said downhole components with said power tong system.

10. The apparatus of claim 2, wherein the downhole components may be a drill bit, a stabilizer, centralizer, drill pipe, or other suitable tubular, or bottom hole assembly.

11. An apparatus for making up and breaking out threaded connections of downhole components, away from a drilling rig wellbore, with downhole components being made up for subsequent insertion in a drilling string or assembly, or alternately, downhole components being broken out after removal from the wellbore, comprising:
a plurality of alignment platforms adapted for transporting or aligning in a generally horizontal mode a first downhole component and a second downhole component, each of said first and second downhole components having a central axis;
a first power tong having an opening with a central axis, said first power tong being configured such that said opening may receive the first downhole component being moved into said opening, wherein at least two of said plurality of alignment platforms are configured for being actuated to foster tri-axial alignment in a horizontal orientation of the first downhole component with respect to said central axis of said first power tong opening and the central axis of the second downhole component, and wherein said first power tong is adapted for gripping and holding in a fixed position the first downhole component, said first power tong holding the first downhole component with a first grip pressure;
a second power tong having an opening with a central axis which is co-axial with said opening of said first power tong, said second power tong being configured such that said second power tong opening may receive the second downhole component being moved into said second power tong opening, wherein at least two of said plurality of alignment platforms are configured for facilitating horizontal alignment of the central axis of the second downhole component tri-axially with respect to said central axis of said second power tong and the central axis of the first downhole component, and wherein said second power tong is adapted for gripping and holding the second downhole component with a second grip pressure, and wherein said second power tong is adapted for applying sufficient torque for a final making up and breaking out of the threaded connection, said second power tong gripping respective of the second downhole component with a second grip pressure for said applying of sufficient torque;
a power spinner configured for being aligned with the central axis of the second downhole component, said power spinner having rolling members adapted to rotably cradle the second downhole component so as to selectively rotate the second downhole component with respect to the first downhole component, said power spinner being adapted for use during make up or break out of the threaded connection;
an alignment platform circuit for activating said alignment platforms for leveling and positioning the downhole components; and
a grip control circuit for controlling said first power tong and said second power tong, said grip control circuit being operable for selectively applying a first grip pressure to the first downhole component by said first power tong and for selectively applying a second grip pressure to the second downhole component by said second power tong so as to make up and break out the threaded connection of the first and second downhole components.

12. The apparatus of claim 11, further comprising:
a power spinner control circuit to produce a spin control signal, wherein said spin control signal is used to selectively rotate the downhole components during making up and breaking out.

13. The apparatus of claim 1 1, further comprising:
at least two power tongs each having a central axis oriented co-axially and horizontally with respect to each other, wherein said power spinner has at least two spin-up rollers each having a central axis oriented generally parallel with respect to said at least two power tongs.

14. The apparatus of claim 11, further comprising:
a base frame configured for mounting said first and second power tongs.

15. The apparatus of claim 11, further comprising:
a base frame configured for mounting at least one of said plurality of alignment platforms.

16. The apparatus of claim 11, further comprising:
a base frame for mounting said first and second power tongs and for fixedly securing at least one alignment platform horizontally and laterally with respect to said power tongs so as to foster tri-axial alignment of at least one downhole component with respect to said power tongs.

17. The apparatus of claim 1 1, wherein each of said first and second power tongs has a plurality of dies circumferentially and substantially equidistantly arranged with respect to each of said central axes of said power tong openings so as to establish a reference datum axis of said power tong system to facilitate alignment of said downhole components with said power tong system.

18. The apparatus of claim 11, wherein the downhole components may be a drill bit, stabilizer, centralizer, drill pipe, or other suitable tubular, or bottom hole assembly.

19. A method for making up and breaking out threaded connections of downhole components, away from a drilling rig wellbore, with downhole components being made up for subsequent insertion in a drilling string or assembly, or alternately, downhole components being broken out after removal from the wellbore, comprising:
positioning a plurality of alignment structures at a predetermined distance apart for selectively manipulating and aligning in a generally horizontal mode a plurality of downhole components in a horizontal orientation; and
actuating a power tong system for making up and breaking out threaded connections of downhole components being selectively manipulated and aligned horizontally by said plurality of alignment structures.

20. A method for making up and breaking out threaded connections of downhole, away from a drilling rig wellbore, with downhole components being made up for subsequent insertion in a drilling string or assembly, or alternately, downhole components being broken out after removal from the wellbore, comprising:
positioning a plurality of alignment platforms at predetermined distance apart with said alignment platforms being adapted for transporting or aligning in a generally horizontal mode a first downhole component and a second downhole component, each of said first and second downhole components having a central axis;
using a first power tong having an opening with a central axis, said first power tong being configured such that said opening may receive said first downhole component being moved into said opening;
providing at least two of said plurality of alignment platforms configured for horizontally aligning the central axis of the first downhole component tri-axially with respect to said opening of said first power tong and the central axis of the second downhole component;
using a first power tong being adapted for gripping and holding in a fixed position the first downhole component, said first power tong adapted for holding the first downhole component with a first grip pressure;
using a second power tong having an opening with a central axis which is co-axial with said opening of said first power tong, said second power tong being configured such that said opening may receive the second downhole component being moved into said opening,
providing at least two of said plurality of alignment platforms configured for facilitating horizontal alignment of the central axis of the second downhole component tri-axially with respect to said opening of said second power tong and the central axis of the first downhole component; aligning said first and second downhole components with the central axes of said power tong openings;
positioning a power spinner for alignment with the central axis of the second downhole component so as to rotably cradle the second downhole component and for selectively rotating the second downhole component with respect to the first downhole component during making up or breaking out of the threaded connection;
using said second power tong being adapted for gripping and holding the second downhole component with a second grip pressure, and wherein said second power tong is adapted for applying sufficient torque for a final making up or breaking out of the threaded connection, said second power tong gripping respective of the second downhole component with a second grip pressure for said applying of sufficient torque;
providing an alignment platform circuit for activating said alignment platforms for leveling and transporting the downhole components; and
providing a grip control circuit for controlling said first power tong and said second power tong, said grip control circuit being operable for selectively applying a first grip pressure to the first downhole component by said first power tong and for selectively applying a second grip pressure to the second downhole component by said second power tong so as to make up and break out the threaded connection of the first and second downhole components.

21. The method of claim 20, further comprising:
providing a power spinner control circuit to produce a spin control signal for selectively rotating the second downhole component during making up and breaking out.

22. The method of claim 20, further comprising:
providing a base frame for mounting said first and second power tongs and for fixedly securing at least one alignment platform horizontally and laterally with respect to said power tongs so as to foster tri-axial alignment of at least one downhole component with respect to said power tongs.

23. The method of claim 20, further comprising:
arranging a plurality of dies circumferentially and equidistantly around said central axes of each of the power tong openings and actuating said dies such that they are equidistant from said central axes so as to establish a reference datum axis of said power tong system to facilitate alignment of said downhole components with said power tong system.

24. The method of claim 20, wherein the downhole components may be a drill bit, stabilizer, centralizer, drill pipe, or other suitable bottom hole assembly.
